(19) United States
(12) Patent Application Publication
(10) Pub. No.: US 2004/0071850 A1
(43) Pub. Date: Apr. 15, 2004

(54) Use of temperature changes to facilitate processing and handling of energy food products

(75) Inventors: Ralph Lee, Hampton, NJ (US); Edward L. Rapp, Blairstown, NJ (US); Jamie Troy, Columbia, NJ (US); Jeannette Dido, Hoboken, NJ (US); Douglas Mann, Belvidere, NJ (US); Thomas Collins, Nazareth, PA (US); Kevin Rabinovitch, Hackettstown, NJ (US)

Correspondence Address: FITZPATRICK CELLA HARPER & SCINTO, 30 ROCKEFELLER PLAZA, NEW YORK, NY, 10112, US

(73) Assignee: Mars, Incorporated, McLean, VA

(21) Appl. No.: 10/272,352

(22) Filed: Oct. 15, 2002

(51) Int. Cl. A23L 1/30

(52) U.S. Cl. 426/520; 426/72; 426/524

(57) ABSTRACT

The present invention is directed to a method of changing a material property of an energy food product or intermediary of the energy food product prior to treatment by a unit operation during manufacturing. The method comprises the steps of: providing the energy food product or the intermediary, wherein the energy food product or the intermediary has at least one material property that changes upon experiencing an effective temperature change during manufacturing; changing the temperature of the energy food product or the intermediary by an amount effective to cause at least one desired material property change; and, optionally, transporting the energy food product or the intermediary to the unit operation.

### BACKGROUND OF THE INVENTION

1. Field of the Invention

The present invention relates to a method of making an energy food product. More particularly, the present invention relates to a method of making an energy food product by reducing or increasing the product temperature to facilitate processing and handling of the product.

2. Description of Related Art

Food products that identify themselves as energy food products are gaining in popularity among all consumers. The thought of eating a nutritious food product that is shelf stable and packaged in a portable form is appealing to most people, especially individuals who feel they need a functional benefit from the nutrients offered by such products.

There are many energy food products in various forms. Manufacturing any of these forms can present a processing challenge. For example, an energy food product may consist of an extruded or formed mass of protein, vitamins, nutrients, and other components, which has a very malleable form that deforms rather easily. This type of product can pose a processing nightmare during cutting and/or packaging operations.

### BRIEF SUMMARY OF THE INVENTION

The present invention is directed to a method of changing a material property of an energy food product or intermediary of the energy food product prior to treatment by a unit operation during manufacturing. The method comprises the steps of: (a) providing the energy food product or the intermediary, wherein the energy food product or the intermediary has at least one material property that changes upon experiencing an effective temperature change during manufacturing; (b) changing the temperature of the energy food product or the intermediary by an amount effective to cause at least one desired material property change; and, (c) optionally, transporting the energy food product or the intermediary to the unit operation.

The present invention also includes a method for preparing an energy food product for packaging. The method comprises the steps of: (a) providing an energy food product having at least one material property that changes upon experiencing an effective temperature change during manufacturing; (b) effectively cooling the temperature of the energy food product or a portion thereof by an amount effective to cause at least one desired material property change; and, (c) optionally, transporting the energy food product to a packaging operation.

### DETAILED DESCRIPTION OF THE INVENTION

Processing of energy food products and their intermediary products and forms, can be expedited by changing a material property of the energy food product or intermediary product. This is readily achieved by the method of the present invention, which changes at least one material property of the energy food product or intermediary by changing the temperature of the energy food product or intermediary product.

For the purposes of the present invention, energy food products are food products that are shelf stable, in a portable form, and based on a 55 g serving size provides about 2 to about 55 g of carbohydrates, about 1 to about 5 g of fortification components (e.g., vitamins, minerals, antioxidants, herbs, etc.), about 5 to about 40 g of protein, about 2 to about 8 g of fat, about 170 to about 300 calories, and has a moisture content of at least about 3% by weight.

Also, for the purposes of the present invention, the intermediary of the energy food product is understood to be any in-process product form of the energy food product prior to completion of the manufacturing process.

The base matrix is the primary component in the energy food product. It may be comprised of nutrient components and/or bulk components such as grains, cereals, rice, nuts, fruit inclusions, chocolate pieces, vegetable pieces, syrups, and the like. The components may be processed in many different ways. For example, the components may be handled and combined in a gentle mixing process to ensure that the components remain substantially intact and are visually identifiable in the base matrix. Alternatively, the components may be processed through a grinding or pulverizing device, such as a comminutor, to create a substantially homogeneous mass.

Nutrient components provide the base matrix with nutrients such as for example, protein, vitamins, minerals, and the like. The preferred protein sources are for example, whey, soy, casein, egg, milk, and the like. The preferred vitamins are for example, vitamin A, vitamin C, vitamin D, vitamin E, vitamin K, and their derivatives and/or pro-vitamins. Preferred vitamins also include B vitamins such as, for example, biotin, folic acid, niacin, niacinamide, pantothenate, pyridoxine hydrochloride, riboflavin, thiamin hydrochloride, and the like. The-preferred minerals include but are not limited to bromine, calcium, chromium, copper, iodine, iron, magnesium, manganese, phosphates, phosphorus, potassium, selenium, sodium, sulfur, and zinc.

Additionally, the base matrix may contain other nutrient components. For example amino acids such as arginine, histidine, isoleucine, leucine, lysine, methionine, phenylalanine, threonine, tryptophan, valine, alanine, aspartic acid, glutamic acid, glutamine, glycine, serine, tyrosine, creatine, and the like may be included as nutrient components in the base matrix. Moreover, the nutrient components may be phytochemicals, sterols, lycopine, herbal supplements such as ginseng, guarana, yerba mate, and the like.

The moisture content of the base matrix is from about 3 wt. % to about 15 wt. % of the total weight of the base matrix. About 5 wt. % to about 12 wt. % is the preferred range. In addition, to help maintain product stability, the water activity level of the base matrix is designed to be from about 0.3 to about 0.6.

The energy food product or intermediary product of the present invention exhibits material property sensitivity to temperature changes of sufficient magnitude during manufacturing operations. Typically, the temperature of the energy food product or intermediary product will be from about 0° C. to about 75° C. prior to the temperature change.

A variety of material property changes may result by changing the temperature of the energy food product or intermediary. For example, the energy food product or intermediary may experience a material property change in product rigidity, product cohesiveness, product surface adhesiveness, viscosity, rate of cold flow, or any number of other similar desirable changes in material property dependent upon the temperature of the product.

By changing the temperature of the energy food product or intermediary during manufacturing, the desired material property change can be brought about. Generally, the temperature of the energy food product is either lowered or raised by an amount effective to produce the intended result, i.e. a desired material property change. It is desirable to effectuate the desired material property change by adjusting the product or intermediary product temperature by about 2° C. or more, preferably about 3° C. or more, and more preferably about 5° C. or more. In a preferred embodiment, the desired material property change is brought about by an effective temperature change to the product or intermediary product by about 2° C. to about 50° C., preferably about 2° C. to about 25° C., and most preferably about 5° C. to about 25° C.

In many instances, the desired material property change is brought about by cooling the energy food product or intermediary to a lower temperature. Cooling of the product is achieved by any suitable means. For example, the energy food product may be cooled in a cooling tunnel, blast cooling, vacuum cooled, or cooled in any other manner to effectuate the desired material property change. Preferably, the product or intermediate product will be cooled to a temperature of about 0° C. to about 25° C. More preferably, to a temperature of about 0° C. to about 18° C., even more preferably, about 5° C. to about 18° C., and most preferably, about 10° C. to about 18° C. At these temperatures, a material property change such as increased rigidity may occur in the energy food product. Typically, the product or intermediate product starts at a temperature of about 75° C. or below. More preferably the temperature is about 15° C. to about 50° C., even more preferably, about 15° C. to about 35° C., and most preferably, about 20° C. to about 30° C.

In an alternative embodiment, the effective temperature change that brings about the desired material property change may be an increase in the temperature of the energy food product or intermediary. This is generally accomplished by heating the energy food product or intermediary. Suitable means of heating include, but are not limited to, applying hot air, heating in an oven, microwave heating, steam heating, and other similar techniques. The energy food product or intermediary is heated to a temperature sufficient to effectuate the desired material property change. Preferably, the product or intermediate product will be heated to a temperature of about 15° C. to about 65° C., more preferably, about 20° C. to about 60° C., and most preferably, about 25° C. to about 50° C. Preferably, the product or intermediate product temperature will be heated to about 0° C. to about 60° C., preferably about 25° C. to about 50° C. The product or intermediate product will generally be at about 2° C. to about 60° C., more preferably, about 5° C. to about 45° C., and most preferably, about 10° C. to about 30° C., prior to increasing the temperature.

Following are test methods that can be used to measure product rigidity, product cohesion, and product adhesion. When using any of these test methods, the product should be shaped to have a thickness of about 5 mm to about 30 mm, a length of about 90 mm to about 125 mm, and a width of about 10 to about 50 mm.

Product rigidity is a measure of the rate of product deflection in a given temperature range, over a set period of time. It can be measured by taking a product and extending it between two points that are 7.5 cm apart, leaving the middle portion of the product without support underneath. After 60 minutes has passed, the deflection in the center of the product is measured. The rigidity test is performed at a given product temperature between about 50° C. to about 0° C.

Product cohesion is a measure of how well the product sticks together or stays intact when tensile forces are applied. It can be measured by measuring the force required to pull apart the product over 5 seconds. One end of the product is placed in a stationary holder designed to grab the end of the product, while a clip is attached to the opposite end. Attached to the clip is a cable that is adjusted to be taut. The force required to pull the cable a distance of 2.5 cm is measured and recorded. As the cable moves, tensile forces act upon the product and tears it. Testing is performed at a given product temperature between about 0° C. to about 50° C.

Product adhesion is a measure of how well the product sticks to a surface. It can be measured by recording the force that is required to pull the product from a 316 ss mill finished surface at a given temperature between about 0° C. to about 50° C. The testing apparatus for measuring product adhesion is similar to the testing, apparatus that is used to measure product cohesion. However, for testing product adhesion, the bottom surface of the product is laid flat onto a stainless steel surface, while a clip is attached to one end of the product. Here again, a cable is connected to the clip and adjusted to be taut. The cable is pulled 2.5 cm using a measured force in order to partially lift the product from the stainless steel surface.

The change in product rigidity, product cohesiveness, product surface adhesiveness, viscosity, rate of cold flow, etc., must be substantial enough to properly prepare the energy food product or intermediary product for the next processing unit operation. A material property change of about 20% or greater is desired. Preferably, the material property change is about 40% or greater, and more preferably, the material property change is about 60% or greater.

The energy food product or intermediary product may take on a wide range of shapes and configurations. For example, the product may be, a flat slab, a single or multilayered bar, an enrobed bar, a square, a pie, a cylinder, spheroid, tube, triangle, oval, and the like. The preferred shape is a flat slab.

It is preferred that the change in temperature of the energy food product or intermediary does not induce a substantial phase change in the water in the product. That is, the change in temperature does not cause the water in the energy food product or intermediary to change, for example, from a solid phase to a liquid phase or vice versa.

The material property is altered to facilitate unit or manufacturing operations that may be used to produce the energy food products. This may be necessary where it is advantageous to have the product behave in a certain manner prior to further processing of the product. For example, to improve cutting operations such as scoring, slitting, or guillotining, it may be necessary to stiffen and increase the rigidity of the energy food product or intermediary.

Additional unit operations that may benefit from material property changes include, but are not limited to crimping, forming, depositing, stringing, dusting, coating, transferring, orienting, positioning, collating, packaging and the like.

Optionally, a transporting step is included to move the energy food product or intermediary to a unit operation, prior to treatment. Any suitable means may be used to transport the energy food product or intermediary. For example, means such as conveying, lifting, pushing, blowing, vacuuming, fluidizing, vibrating, are all contemplated.

In one embodiment, the energy food product is a bar that is manufactured using a method to preserve component integrity, i.e. leaving the components substantially intact and visually identifiable. The components may be combined with a binder that serves to bond the components together. The binder is preferably made with a carbohydrate based syrup, such as a sugar syrup, that is sensitive to temperature changes, which ultimately affects the viscosity of the binder. For example, an effective increase in temperature would decrease product viscosity, making the energy food product or intermediary less rigid and cohesive, but more adhesive to surfaces such as conveyor belts, packaging materials, and the like. Conversely, an effective decrease in temperature would increase product viscosity. This generally results in a product that is more rigid and cohesive, but may or may not affect the adhesive properties of the product.

Another embodiment that is contemplated is an energy food product that is a substantially homogeneous plasticized mass. Preferably the plasticized mass is formed or cut into the shape of bars. Various components are processed through a grinding or pulverizing device that breaks the components down into particles. The compilation of ground particles are combined with a binder, e.g., carbohydrate based syrup, liquid fat, and/or water, to form the plasticized mass. The components may be ground together to produce the homogeneous mass or ground separately and later combined. Either way, the net result is a compilation or agglomerated mixture of the components that may be the final energy food product or a portion of it. The advantage of grinding the components separately is that it allows different components to be ground to different particle sizes, which provides a greater range of textures.

In a particular embodiment, the present invention is directed to a method for preparing an energy food product for packaging. The method comprises the steps of: providing an energy food product having at least one material property that changes upon experiencing an effective temperature change during manufacturing; effectively cooling the temperature of the energy food product or a portion thereof by an amount effective to cause at least one desired material property change; and optionally, transporting the energy food product to a packaging operation.

The method may also include the step of packaging the energy food product. This may be performed using a packaging apparatus such as, for example, flow wrappers, vertically fed baggers, di-fold wrappers, bunch wrappers, twist wrappers, tube fillers, stick packers, blister packs, and the like.

### EXAMPLE 1

TABLE 1
Pre Blend Mixture

Ingredient
Corn Syrup Blend
Consisting of one or more ingredients selected
from the list of: High Fructose, Corn Syrup, Honey
and 63 DE corn syrup
Protein Blend
Consisting of one or more ingredients selected
from the list of: Vegetable or Animal Protein,
Whey Protein Isolate, Calcium Caseinate, Soy
Protein Isolate and peanut flour or their derivatives
Salt
Flavorings
Artificial and/or Natural flavors such as vanillin,
cinnamon and cocoa powder

TABLE 2
Fortification Slurry

Ingredient
Glycerin
Fortification Blend
Corn Syrup

TABLE 3

| Component | Percent by Weight |
|---|---|
| Pre Blend Mixture | 69.3 |
| Fortification Slurry | 20.7 |
| Soy Crisps | 10.0 |
| | 100.0 |

The ingredients as set forth in Table 1 and Table 2 were mixed in separate mixers. The fortification slurry and soy crisps were then added in the ratio as set forth in Table 3 to the pre blend mixture and mixed to produce the finished, blended energy food product.

The finished, blended product was cooled and formed into a slab 8 mm high. The slab was cooled in a cooling tunnel to a temperature of 25° C. and then slit into 35 mm wide ribbons and then cut into a finished length of 100 mm, thereby forming bars.

At this point, the bars lacked firmness, which would hinder transferring and wrapping them. Therefore further cooling was required. The cooling was performed in a cooling tunnel, where 5° C. cooling air was directed on the top of the product and cooling platens contacted the underside of the belt conveyor carrying the product. The cooling platens were controlled to a temperature of 5° C. The heat transfer coefficient of the impingement air in the cooling tunnel above and below the belt was about 35 w/m²° C.

The cooled bars were then passed through the wrapping process where they were wrapped in a flow wrap machine, cartoned and cased. The wrapped bars gradually rewarmed to an ambient temperature of about 22° C.

### EXAMPLE 2

The energy bar product as produced in Example 1. The slit and cut bars are to be transported up an incline conveyor prior to wrapping. However, bars at 25° C. tend to slide on the incline conveyor belt. To reduce the tendency of sliding, a heater platen is attached contacting the bottom of the incline conveyor belt prior to the incline. The heater platen warms the bottom of the energy bar product to about 35° C. to make the bottom of the product more sticky. This stickiness allows the energy bar product to be conveyed on the incline conveyor. The energy bar product is then cooled to the desired wrapping temperature as set forth in Example 1.

### EXAMPLE 3

An energy bar product is produced as set forth in Example 1. The slabbed product is to be transported to a lower level in the factory. This is accomplished by conveying the product over a round drum, flipping over the product. The product surface contacting the drum must be warmed to 35° C. so that the product is sticky enough to remain in contact with the drum. At the point of transfer, the product is doctored (scraped) off the drum and dropped onto another conveyor. The product is then cooled as required for further processing.

### EXAMPLE 4

A grain based, energy bar product base is produced in a manner similar to that set forth in Example 1. The pre blend mixture consists of rice, soy crisps, oats, wheat flakes, corn syrups and caramel. The ingredients are blended in a Z-blade batch style mixer to produce the pre blend mixture. A fortification slurry is prepared by mixing the ingredients as set forth in Table 2. The fortification slurry is then added to the pre blend mixture in the Z-blade mixer and mixed to produce the finished, blended grain-based energy bar base product.

The base product is then formed into a slab using forming rolls and has an equilibrated mass temperature of 35° C.

The desired final product has a thin caramel layer added to the grain base. The grain base, as formed, is too cold for proper adhesion between the grain base and the desired caramel layer. To improve the adhesion, the top surface of the grain base is heated to 50° C. prior to the application of the caramel layer. Infrared heaters are used to accomplish the heating. The combined product is then cooled, slit and cut as set forth on Example 1.

### EXAMPLE 5

An energy bar product is produce as set forth in Example 1. The desired final form is not a bar, but a cylinder. After cutting, the bars are warmed to 50° C. At this point, the bars are malleable and easily shaped. The bars are passed through a mechanism which reforms the bars into cylinders. The cylinders are then cooled as set forth in Example 1 to prepare them for packaging.

While the invention has been described above with reference to specific embodiments thereof, it is apparent that many changes, modifications, and variations can be made without departing from the inventive concept disclosed herein. Accordingly, it is intended to embrace all such changes, modifications, and variations that fall within the spirit and broad scope of the appended claims. All patent applications, patents, and other publications cited herein are incorporated by reference in their entirety.

What is claimed is:

1. A method of changing a material property of an energy food product or intermediary of said energy food product prior to treatment by a unit operation, comprising the steps of:
(a) providing said energy food product or said intermediary having at least one material property that changes upon experiencing an effective temperature change during manufacturing;
(b) changing the temperature of said energy food product or said intermediary by an amount effective to cause at least one desired material property change; and,
(c) optionally, transporting said energy food product or said intermediary to said unit operation.

2. The method of claim 1, further comprising the step of performing said unit operation on said energy food product or said intermediary.

3. The method of claim 1, wherein said unit operation is selected from the group consisting of: scoring, slitting, guillotining, crimping, forming, depositing, stringing, dusting, coating, transferring, orienting, positioning, collating, packaging and combinations thereof.

4. The method of claim 1, wherein said step of changing the temperature of said energy food product or said intermediary is a cooling step.

5. The method of claim 1, wherein said step of changing the temperature of said energy food product or said intermediary is a heating step.

6. The method of claim 1, wherein the desired material property change is an increase in product rigidity or a decrease in product rigidity.

7. The method of claim 1, wherein the desired material property change is an increase in surface adhesiveness or a decrease in surface adhesiveness.

8. The method of claim 1, wherein the desired material property change is an increase in product cohesiveness or a decrease in product cohesiveness.

9. The method of claim 1, wherein said energy food product is cooled to a temperature of about 0° C. to about 25° C.

10. The method of claim 1, wherein said energy food product is heated to a temperature of about 15° C. to about 65° C.

11. The method of claim 1, wherein the effective temperature change is from about 2° C. to about 50° C.

12. The method of claim 1, wherein the desired material property change occurs without a substantial phase change.

13. A method of preparing an energy food product for packaging, comprising the steps of:
(a) providing an energy food product having at least one material property that changes upon experiencing an effective temperature change during manufacturing;
(b) effectively cooling the temperature of said energy food product or a portion thereof by an amount effective to cause at least one desired material property change; and,
(c) optionally, transporting said energy food product to a packaging operation.

14. The method of claim 13, further comprising the step of performing said packaging operation on said energy food product.

15. The method of claim 13, wherein the desired material property change is an increase in product rigidity or a decrease in product rigidity.

16. The method of claim 13, wherein the desired material property change is an increase in surface adhesiveness or a decrease in surface adhesiveness.

17. The method of claim 13, wherein the desired material property change is an increase in product cohesiveness or a decrease in product cohesiveness.

18. The method of claim 13, wherein said energy food product is cooled to a temperature of about 0° C. to about 25° C.

19. The method of claim 13, wherein said packaging operation includes a packaging apparatus selected from the group consisting of: flow wrappers, vertical fed baggers, di-fold wrappers, bunch wrappers, twist wrappers, tube fillers, stick packers, blister packs, and combinations thereof.

20. The method of claim 13, wherein the desired material property change occurs without a substantial phase change.
